(19) United States
(12) Patent Application Publication
(10) Pub. No.: US 2013/0248002 A1
(43) Pub. Date: Sep. 26, 2013

(54) SYSTEM AND METHOD OF OPERATING A SOLENOID VALVE AT MINIMUM POWER LEVELS

(71) Applicant: Automatic Switch Company, Florham Park, NJ (US)

(72) Inventors: John J. Haller, Boonton, NJ (US); Stephen P. Glaudel, Lebanon, NJ (US); Gregory J. Volz, Lincoln Park, NJ (US)

(73) Assignee: Automatic Switch Company, Florham Park, NJ (US)

(21) Appl. No.: 13/900,683

(22) Filed: May 23, 2013

Related U.S. Application Data
(62) Division of application No. 12/137,428, filed on Jun. 11, 2008, now abandoned.

(51) Int. Cl. G05D 16/20

(52) U.S. Cl. CPC G05D 16/20
USPC 137/14; 137/625.61

(57) ABSTRACT

The inventions disclosed and taught herein are further directed to a solenoid valve configured for operation at minimum power levers comprising: a casing; a magnetic coil within the casing adapted for inducing a magnetic flux when energized; a plunger selectively actuated by the magnetic coil to operate the solenoid valve; and at least one energy storage device within the casing adapted to store energy and selectively energize the magnetic coil by applying the energy to the magnetic coil.

### CROSS REFERENCE TO RELATED APPLICATIONS

This Application is a Divisional of U.S. patent application Ser. No. 12/137,428, filed Jun. 11, 2008, which is incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to solenoid valves; and more specifically relate to solenoid valves that are capable of operating at minimum power levels.

2. Description of the Related Art

A solenoid valve can be an electromechanical valve for use with liquid or gas controlled by running or stopping an electrical current through a solenoid, which can be a coil of wire, thus changing the state of the valve. Solenoid valves can have two or more ports: in the case of a two-port valve the flow is switched on or off; in the case of a three-port valve, the flow is switched between the two inlet or outlet ports. Besides the plunger-type actuator which is used most frequently, pivoted-armature actuators and rocker actuators are also used.

A solenoid valve has two main parts: the solenoid and the valve. The solenoid converts electrical energy into mechanical energy which, in turn, opens or closes the valve mechanically. Solenoid valves can use metal seals or rubber seals, and may also have electrical interfaces to allow for easy control. A spring may be used to hold the valve opened or closed while the valve is not activated.

There exists today a need for a valve actuator to be able to operate at very low power levels, for example, levels in the range of ten milliwatts. The need for such devices exists in applications where operating power may be constrained. Examples are valves operating in hazardous locations complying with the principal of Intrinsic Safety, especially those devices that operate as part of a process control bus system such as Foundation Fieldbus or Profibus PA. Other applications could be related to battery or solar cell remote applications where there may be no distributed power available to power the device. The present state of the art that fills this need is provided by either valves that operate using the principal of the piezoelectric effect, or miniature flapper nozzle devices. However, the piezoelectric valves suffer from limited operating temperature range, and problems with memory effect that do not allow for positive turnoff. Flapper nozzle valves consists of many high precision parts which may lead to very high cost. Solenoid valves have a history of reliability and cost effectiveness, but may be limited by practical design considerations and may typically require power levels is of 0.25 watts or greater.

The inventions disclosed and taught herein are directed to a system and method that uses a combination of techniques, both mechanical and electrical, to produce a cost effective solenoid valve design which operates at very low power levels, for example at power levels of 0.025 watts or less.

There remains a need for a system and method of operating a solenoid valve at minimum power levels.

### BRIEF SUMMARY OF THE INVENTION

The inventions disclosed and taught herein are directed to a solenoid comprising: a casing; a magnetic coil encapsulated in the casing adapted for inducing a magnetic flux when supplied with electrical current; a plunger supported for linear displacement positioned within the coil, adapted to latch and unlatch a solenoid; and at least one capacitor adapted to store energy to latch or unlatch the solenoid.

The inventions disclosed and taught herein are further directed to a method of operating a solenoid comprising: storing energy in an at least one capacitor; determining whether the at least one capacitor contains sufficient energy to operate the solenoid; receiving a signal to operate the solenoid; and discharging energy from the capacitor to operate the solenoid.

The inventions disclosed and taught herein are further directed to a solenoid valve comprising: a casing; a magnetic coil encapsulated in the casing adapted for inducing a magnetic flux when supplied with electrical current; a plunger supported for linear displacement positioned within the coil, adapted to latch or unlatch the solenoid valve; at least one capacitor adapted to energize the magnetic coil; and a piston pneumatically connected to the solenoid valve adapted to latch or unlatch the solenoid valve.

### BRIEF DESCRIPTION OF THE SEVERAL VIEWS OF THE DRAWINGS

FIG. 1 illustrates a particular embodiment of a solenoid valve system that can operate at minimum power levels utilizing certain aspects of the present inventions.

FIG. 2 illustrates another particular embodiment of a solenoid valve system that can operate at minimum power levels utilizing certain aspects of the present invention.

FIG. 3 illustrates another particular embodiment of a solenoid valve system that can operate at minimum power levels utilizing certain aspects of the present invention, such as a pneumatic monostable solenoid.

FIG. 4 illustrates a particular embodiment of a valve subsystem utilizing certain aspects of the present invention.

FIG. 5 illustrates another embodiment of a valve subsystem utilizing certain aspects of the present invention.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. It must be understood that the inventions disclosed and taught herein are susceptible to numerous is and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Computer programs for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package.

Applicants have created a solenoid comprising: a casing; a magnetic coil encapsulated in the casing adapted for inducing a magnetic flux when supplied with electrical current; a plunger supported for linear displacement removably positioned within the coil, adapted to latch and unlatch a solenoid; and at least one capacitor adapted to store energy to latch or unlatch the solenoid.

Applicants have created a method of operating a solenoid comprising: storing energy in an at least one capacitor; determining whether the at least one capacitor contains sufficient energy to operate the solenoid; receiving a signal to operate the solenoid; and discharging energy from the capacitor to operate the solenoid.

Applicants have created a solenoid valve comprising: a casing; a magnetic coil encapsulated in the casing adapted for inducing a magnetic flux when supplied with electrical current; a plunger supported for linear displacement positioned within the coil, adapted to latch or unlatch the solenoid valve; at least one capacitor adapted to energize the magnetic coil; and a piston pneumatically connected to the solenoid valve adapted to latch or unlatch the solenoid valve.

The inventions disclosed and taught herein are directed to a system and method that uses a combination of techniques both mechanical and electrical to provide a cost is effective solenoid design that operates at very low power levels.

In order to achieve very low power operation the following two advancements are preferably provided. The first improvement is a means of storing sufficient energy to be able to actuate the solenoid operator so as to operate the valve. This can be accomplished by storing available energy in a storage device, such as capacitor type device, to be used when needed. The second improvement is a means of holding the solenoid in a condition that will keep the valve in the desired position with minimal power. The means to accomplish this task may be (1) a magnetic assisted holding, (2) a special mechanical enhanced holding methods, or (3) a pneumatic assisted techniques.

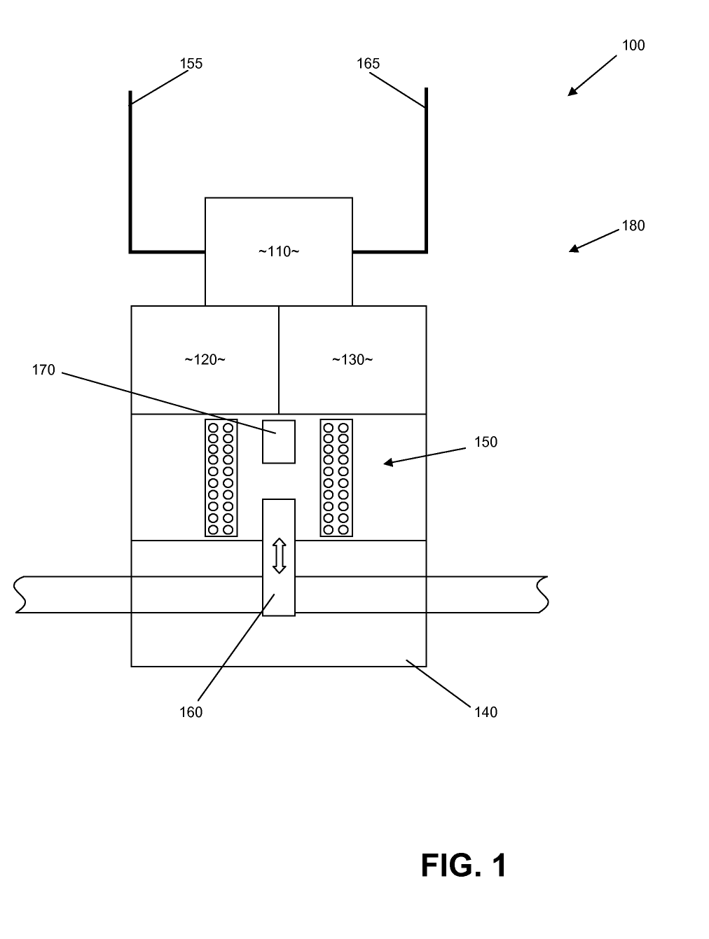

FIG. 1 is an illustration of a particular embodiment of a solenoid valve system that can operate at minimum power levels utilizing certain aspects of the present inventions. The inventions disclosed and taught herein are directed to a magnetic latching solenoid system 100. The system 100 preferably includes a supervisory circuit 110, or intelligent charge control logic, to control two energy storage devices 120 and 130, such as capacitor storage systems, a mechanical valve body 140, and a solenoid, or electromagnetic coil, 150 to move a plunger or armature 160. The supervisory circuit 110 preferably receives two inputs, a power input 155 and a control input 165. The addition of a butt or stop 170 at one end of the solenoid can be used to control the movement, or stroke, of the plunger 160. One or more components of the system 100 may be collectively referred to as a solenoid valve 180.

It should be understood that the illustrations are purposely simplistic, in order to assist in readily understanding the invention. However, it is contemplated that certain components of the inventions may be significantly more complex, depending on specific implementations. For example, the valve body 140 would likely be arranged differently and include more components, such as seals, than those shown.

The system 100 preferably energizes or de-energizes the solenoid, or coil, 150 to latch or unlatch the solenoid valve 180. The solenoid valve 180 can be latched or is unlatched by providing energy to the solenoid 150 which can cause the solenoid coil 150 to become magnetized and thus attract the plunger 160 to a position within the coil 150.

In this embodiment, the two energy storage devices 120 and 130, including, but not limited to, capacitor storage systems, can be utilized to operate the solenoid valve 180. The energy storage device 120, or pick up energy storage device, can provide energy to magnetize the solenoid coil 150 and latch the solenoid valve 180. The second energy storage device 130, or drop out energy storage device, can provide energy to un-latch the solenoid valve 180. The supervisory circuit 110 can control the rate and timing necessary to be able to operate the solenoid valve 180 when required. The supervisory circuit 110 can be a Microchip PIC16F631 programmed to control the solenoid valve 180. The Microchip PIC16F631 data sheet is incorporated herein by reference. The supervisory circuit 110 can be designed such that any necessary unlatch pulse is available even with loss of power in order that the solenoid valve 180 can always be returned to its failsafe mode. This can be accomplished by ensuring the second energy storage device 130 has sufficient power to un-latch the solenoid valve 180 before the first energy storage device 120 latches the solenoid valve 180 thus ensuring the solenoid valve 180 can always be returned to its failsafe mode or un-latched position. Ensuring the second energy storage device 130 has sufficient power can be accomplished by design and/or programming of the supervisory circuit 110.

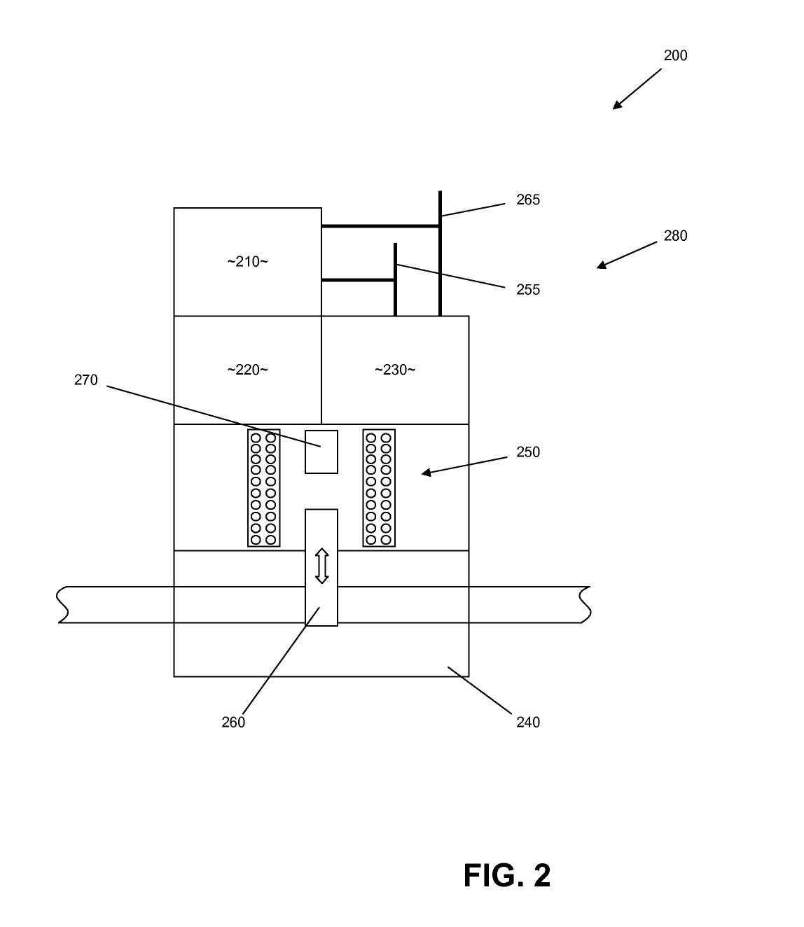

FIG. 2 is an illustration of another particular embodiment of a solenoid valve system that can operate at minimum power levels utilizing certain aspects of the present invention. The inventions disclosed and taught herein are directed to a magnetic latching solenoid system 200. The system 200 preferably includes a supervisory circuit 210, or intelligent charge control logic, to control an energy storage device 220, such as capacitor storage systems, a holding energy circuit 230, a mechanical valve body 240, and a solenoid, or electromagnetic coil, 250 to move a plunger or armature 260. The supervisory circuit 210 preferably receives two inputs, a power input 255 and a control input 265. The addition of a butt or stop 270 at one end of the solenoid can be used to is control the movement, or stroke, of the plunger 260. One or more components of the system 200 may be collectively referred to as a solenoid valve 280.

The system 200 preferably energizes the solenoid, or coil, 250 to latch the solenoid valve 280. In this embodiment, solenoid valve designs, including those described herein, can be further optimized. Generally, low power as used herein is defined as less than 0.25 watts. In a preferred embodiment, the solenoid valve 280 requires only approximately ten milliwatts to operate. However, depending upon the implementation, the system 200 may be fully functional using between approximately five and fifteen milliwatts, with as much as twenty, or even twenty-five, milliwatts being required for certain applications. The energy storage device 220, can be used to store the energy provided by a limited or low power source.

The supervisory circuit 210 can monitor and/or control an energy storage device 220 to provide the required charge to open, or otherwise actuate, the solenoid valve 280. When the energy is sufficient, the energy storage device 220 will discharge the stored energy into the solenoid coil 250, on command, thereby opening the valve 240. It can be appreciated that holding the solenoid valve 280 open requires less power than opening it. Therefore, after energizing, the holding control circuit 230 can provide the required power to hold the solenoid valve 280 open. The supervisory circuit 210 preferably also recharges the energy storage device 220 so that the solenoid valve 280 will be ready to operate again when commanded.

While this embodiment has been described as a normally closed valve, the same principals may be applied to a normally open valve as well. For example, the energy storage device 220 may discharge the stored energy into the solenoid coil 250, on command, thereby closing the valve 240. After energizing, a holding control circuit 280 can provide the required power to hold the solenoid valve 280 closed.

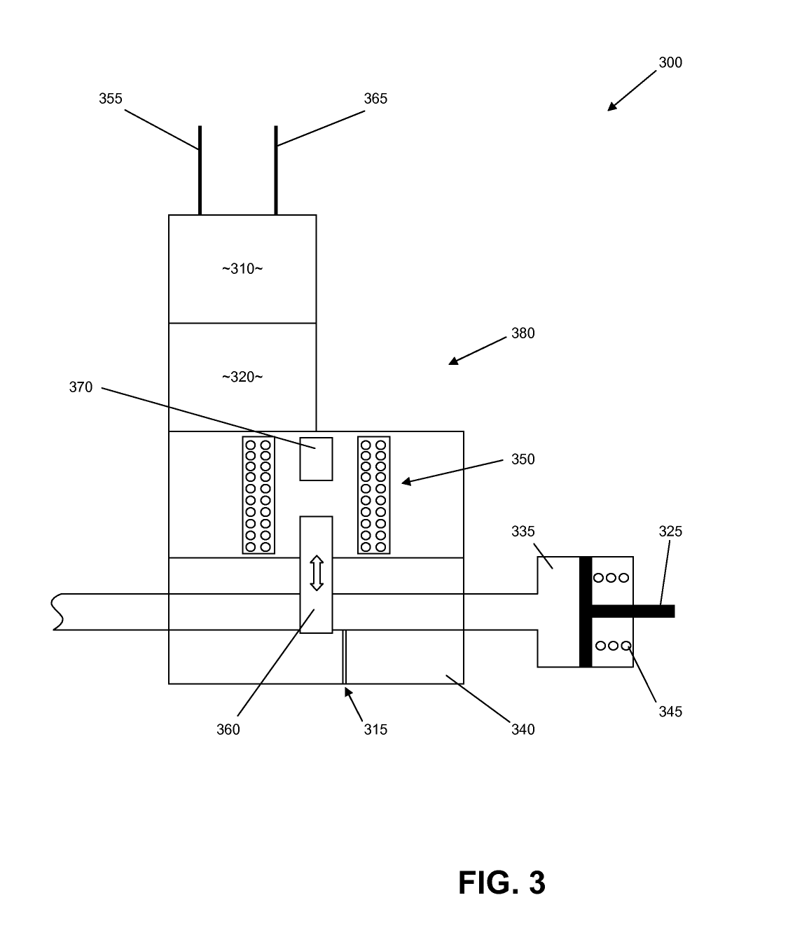

FIG. 3 is an illustration of a particular embodiment of a solenoid valve system that can operate at minimum power levels utilizing certain aspects of the present invention, more specifically, a pneumatic mono-stable solenoid. The inventions disclosed and taught herein are directed to a pneumatic mono-stable hold valve which can be used to control a larger, of otherwise final, valve mechanism. This particular embodiment preferably consists of a three way solenoid valve being driven by a stored energy pulse system. The system 300 preferably includes a supervisory circuit 310, or intelligent charge control logic, to control an energy storage device 320, such as capacitor storage systems, a mechanical valve body 340, and a solenoid, or electromagnetic coil, 350 to move a plunger or armature 360. The supervisory circuit 310 preferably receives two inputs, a power input 355 and a control input 365. The addition of a butt or stop 370 at one end of the solenoid can be used to control the movement, or stroke, of the plunger 360. One or more components of the system 300 may be collectively referred to as a solenoid valve 380.

The system 300 also preferably includes a small controlled bleed orifice 315 in the normally open port of the solenoid valve 380. The solenoid valve 380 is preferably pneumatically coupled to an actuator 325, such as, but not limited to a dead end piston or a bellows, for actuation, latching or unlatching of the final valve. The piston 325 preferably moves back and forth in a cylinder 335 and is biased by a return spring 345 or another bias mechanism.

The intelligent charge control logic 310 can control the storage discharge of the energy storage device 320, which can be used for energy storage. On command to open the solenoid valve 380, the energy stored in the energy storage device 320 can be applied to the solenoid coil 350 and can open the solenoid valve 380 for a period of time necessary to operate the piston 325. The solenoid valve 380 can close and the pressure in the cylinder 335 can decay at a rate controlled by the bleed orifice 315. While the pressure is decaying the intelligent charge control logic 310 can be replenishing the energy in the energy storage device 320. When the pressure decay reaches a predetermined point the solenoid valve 380 can be operated again to re-pressurize the cylinder 335. This process can be repeated until the command to close the valve is asserted to the intelligent charge control logic 310, after which the pressure can be allowed to decay to a point where the piston 325 is fully retracted by the spring 345.

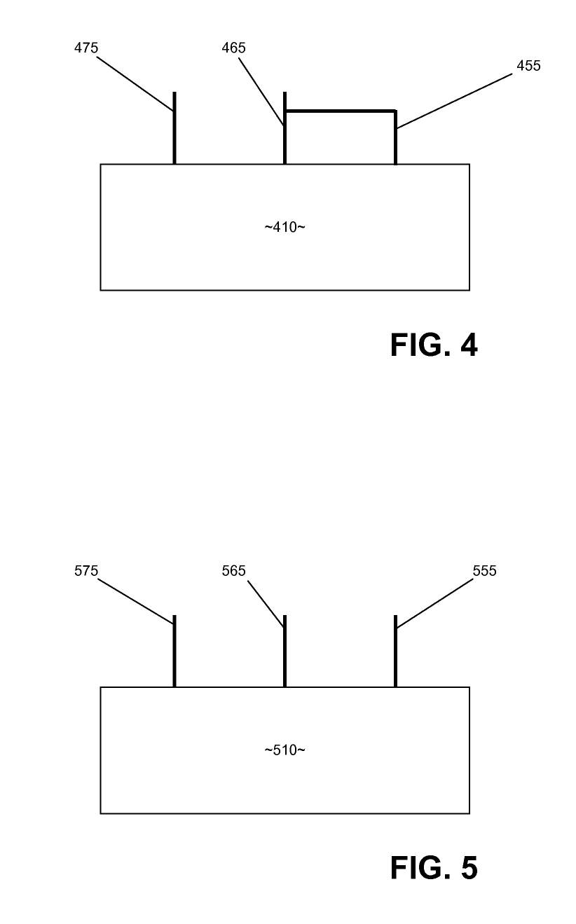

In all the embodiments described, there can be two modes of control that can be applied. FIG. 4 is an illustration of a particular embodiment of a valve subsystem utilizing certain aspects of the present invention, specifically, a two wire approach is shown. In the two wire approach, the power 455 and control 465 can be provided to the intelligent charge control logic 410 by the same wire. That signal is, of course, referenced to a common, or ground, input 475. In this embodiment, it would be appreciated by a person of ordinary skill in the art that this approach can be the standard for most valve devices. An external controller can provide the power and initiates the change of state of the valve.

FIG. 5 is an illustration of a particular embodiment of a valve subsystem utilizing certain aspects of the present invention, specifically a three wire approach can be utilized. In this embodiment, the power can be constantly provided to the intelligent charge control logic 510 on one wire, the power wire 555 and a separate wire can be available for control, the control wire 565. Both signals are, of course, referenced to a common, or ground, input 575. This approach allows for more intelligent control because the power can always be available to onboard electronics to control the storing of energy or for monitoring conditions.

In each of the embodiments discussed above, the components are preferably integral to the system, such that the system comprises a self-contained valve assembly. For example, the components may be contained within the same housing or abutted housings. The control and/or power signals are preferably received from an external control system. In many cases the control signal can be digital and be communicated via a bus system over the power connection and then separated by the use of circuitry with in the system.

Other and further embodiments utilizing one or more aspects of the inventions described above can be devised without departing from the spirit of Applicant's invention. For example, any embodiment, including, but not limited to FIGS. 1-3 can be is designed with either the two wire or three wire approaches of FIGS. 4-5. Further, the various methods and embodiments of the solenoid valve disclosed herein can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A method of operating a solenoid valve comprising:
energizing a solenoid to operate the solenoid valve, thereby applying pressure to a chamber; and
de-energizing the solenoid to close the solenoid valve, thereby causing the pressure in the chamber to decay at a rate controlled by a bleed orifice.

2. The method of claim 1, wherein the pressure in the chamber continuously decays through the bleed orifice.

3. The method of claim 1, wherein the pilot valve is a three-way solenoid valve.

4. The method of claim 3, wherein the bleed orifice is in a normally open port of the three-way solenoid valve.

5. The method of claim 1, further including the step of storing energy in an energy storage device of the solenoid valve.

6. The method of claim 5, the energizing step includes applying the energy stored in the energy storage device to the solenoid.

7. The method of claim 1, further including the step of storing energy in an energy storage device of the solenoid valve while the pressure in the chamber is decaying.

8. The method of claim 1, repeating the steps of energizing and de-energizing upon the pressure in the chamber decaying to a predetermined point.

9. A solenoid valve comprising:
a first port;
a second port;
a bleed orifice in communication with the second port and configured to constantly decay pressure present at the second port;
a plunger configured to allow communication between the first port and the second port when actuated;
a magnetic coil configured to induce a magnetic flux when with energized; and
at least one energy storage device adapted to selectively energize the magnetic coil, thereby actuating the plunger to allow communication between the first port and the second port.

10. The valve of claim 9, further including a supervisory circuit to selectively apply energy stored in the energy storage device to the magnetic coil, thereby energizing the magnetic coil, actuating the plunger, and allowing communication between the first port and the second port.

11. The valve of claim 10, further including a casing, wherein the magnetic coil, the energy storage device, and the supervisory circuit are located within the housing.

12. The valve of claim 10, wherein the supervisory circuit is configured to replenish the energy stored in the energy storage device when the magnetic coil is not energized.

13. The valve of claim 10, wherein the supervisory circuit is configured to re-energize the magnetic coil when the pressure present at the second port decays to a predetermined point.

14. A solenoid valve comprising:
an input port;
an output port;
an exhaust port;
a plunger configured to allow communication between the input port and the output port when actuated and allow communication between the exhaust port and the output port when not actuated,
a magnetic coil configured to induce a magnetic flux when with energized;
at least one energy storage device adapted to selectively energize the magnetic coil, thereby actuating the plunger to allow communication between the input port and the output port; and
a bleed orifice in the exhaust port and configured to constantly decay pressure present at the exhaust port.

15. The valve of claim 14, further including a supervisory circuit to selectively apply energy stored in the energy storage device to the magnetic coil, thereby energizing the magnetic coil, actuating the plunger, and allowing communication between the input port and the output port.

16. The valve of claim 15, further including a casing, wherein the magnetic coil, the energy storage device, and the supervisory circuit are located within the housing.

17. The valve of claim 15, wherein the supervisory circuit is configured to replenish the energy stored in the energy storage device when the magnetic coil is not energized.

18. The valve of claim 15, wherein the supervisory circuit is configured to re-energize the magnetic coil when the pressure present at the exhaust port decays to a predetermined point.
